(19) United States
(12) Patent Application Publication
(10) Pub. No.: US 2011/0279845 A1
(43) Pub. Date: Nov. 17, 2011

(54) INFORMATION PROCESSING APPARATUS, AND CONTROL METHOD AND STORAGE MEDIUM THEREFOR

(75) Inventor: Ritsuto SAKO, Kawasaki-shi (JP)

(73) Assignee: CANON KABUSHIKI KAISHA, Tokyo (JP)

(21) Appl. No.: 13/100,567

(22) Filed: May 4, 2011

(30) Foreign Application Priority Data
May 13, 2010 (JP) 2010-111208

(51) Int. Cl. G06K 15/02

(52) U.S. Cl. 358/1.13

(57) ABSTRACT

An information processing apparatus capable of continuing execution of a job performed thus far, even if a user's screen transition operation is performed while the job is being executed. When a job is executed, an MFP as the information processing apparatus determines whether there is a job previously in execution based on execution states of jobs managed by a cookie information management part. If there is a job previously in execution, the MFP makes an inquiry about an execution result of the job to a job status management unit that manages job execution results on a per job basis, and according to a result of the inquiry, changes an operation screen to be displayed on a display unit and a job to be executed.

### BACKGROUND OF THE INVENTION

1. Field of the Invention

The present invention relates to an information processing apparatus in which operation screens provided by a server are switched to be displayed on a display unit, and relates to a control method and a storage medium for the information processing apparatus.

2. Description of the Related Art

In some information processing apparatus such as a PC, a browser is used to display on a display unit an operation screen provided by a server via a network.

Such an information processing apparatus requests the server to transmit operation screen data, and receives HTML data for displaying an operation screen from an application on the server. The browser of the information processing apparatus analyzes the received HTML data, and based on a description of the HTML data, displays the operation screen on the display unit.

When an instruction is input by a user through the operation screen, the browser notifies the user's instruction to the server, and the application on the server executes processing according to the instruction.

In some of recent MFPs (multi function peripherals) having a scanner, printer, etc., a browser is also used to cause a display unit to display an operation screen provided by a sever and accept a user's instruction input through the operation screen.

For example, Japanese Laid-open Patent Publication No. 2008-003833 proposes a technique for providing, from a server to an MFP, data of an operation screen for inputting an instruction for execution of an MFP function and a control script for controlling the MFP according to operations on the operation screen.

With this proposal, the control script read by the browser gives an instruction to execute processing based on an instruction input through the operation screen. The MFP creates a job corresponding to an MFP function to be executed by the control script.

The created job controls a scanner and a printer of the MFP, and requests a user to perform dialog processing such as inputting an instruction or eliminating an error. The control script receives the dialog processing and performs the next processing.

### SUMMARY OF THE INVENTION

The present invention enables realization of an information processing apparatus capable of continuing execution of a job performed thus far, even if a user's screen transition operation is performed while the job is being executed, and enables realization of a control method and a storage medium for the information processing apparatus.

One aspect of the present invention provides an information processing apparatus comprising a display control unit configured to switchingly display operation screens on a display unit according to a user's operation, the operation screens being provided from an external apparatus, a job execution unit configured to execute a job according to a user's operation on an operation screen displayed on the display unit, and a storage unit configured to store setting information for the job executed by the job execution unit, wherein in a case where the operation screen displayed on the display unit is switched according to a user's operation while the job is being executed by the job execution unit, the job execution unit continues the job in execution based on the setting information for the job stored in the storage unit.

Further features of the present invention will become apparent from the following description of an exemplary embodiment with reference to the attached drawings.

### BRIEF DESCRIPTION OF THE DRAWINGS

FIG. 1 is a view showing an example of an information processing system including an MFP which is one embodiment of an information processing apparatus of this invention;

FIG. 2 is a block diagram showing an example structure of the MFP;

FIG. 3 is a block diagram showing an example structure of a server of the information processing system;

FIG. 4A is a block diagram showing an example software structure of the MFP;

FIG. 4B is a block diagram showing an example software structure of the server;

FIG. 5 is a sequence diagram showing a series of processing performed between a browser of the MFP, a service provider of the MFP, and a web application of the server;

FIG. 6 is a view showing an example of screen transition occurring on an operation/display unit while a series of processing is performed to achieve an MFP function;

FIG. 7 is a view showing an example of a control script and HTML data for screen display;

FIG. 8 is a view showing an example of a scan-in-progress screen displayed on the operation/display unit;

FIG. 9 is a view showing an example of cookie information stored in the browser of the MFP;

FIG. 10 is a view showing an example of a list of job execution results managed by a status determination part of the MFP;

FIG. 11 is a flowchart showing a process performed by the MFP by executing a web application;

FIG. 12 is a flowchart showing return processing performed instep S1103 in FIG. 11 when there is a job which is in a “Setting” state;

FIG. 13 is a flowchart showing return processing performed instep S1104 in FIG. 11 when there is a job which is in a “Reading” state;

FIGS. 14A and 14B are a flowchart showing return processing performed in step S1105 in FIG. 11 when there is a job which is in a “Sending” state;

FIG. 15 is a view showing an example of a selection screen which is displayed on the operation/display unit in step S1306 in FIG. 13 and through which a user instructs whether to continue or terminate processing;

FIG. 16 is a view showing an example of a screen displayed on the operation/display unit in step S1303 in FIG. 13 to notify the user that a job previously in execution has failed; and

FIG. 17 is a view showing an example of a screen displayed on the operation/display unit in step S1408 in FIG. 14A to notify the user that a job previously in execution has succeeded.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

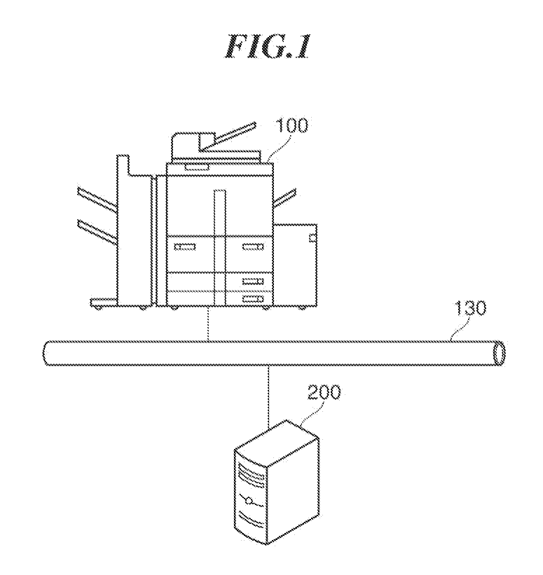

FIG. 1 shows an example of an information processing system including an MFP which is one embodiment of an information processing apparatus of this invention.

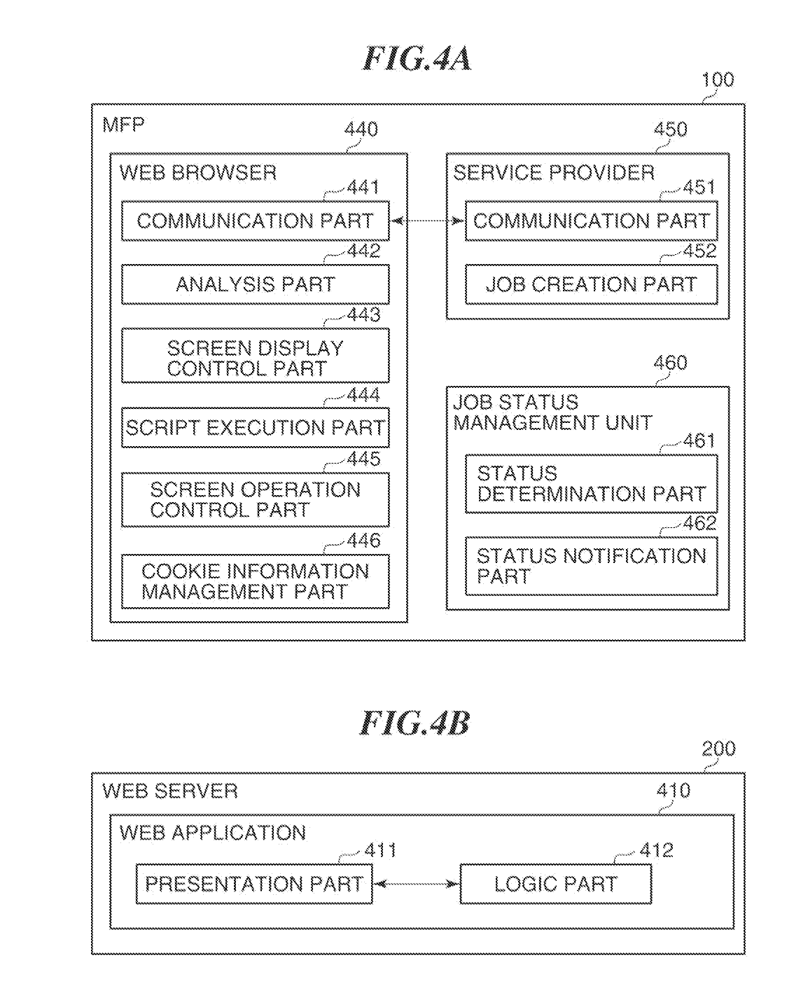

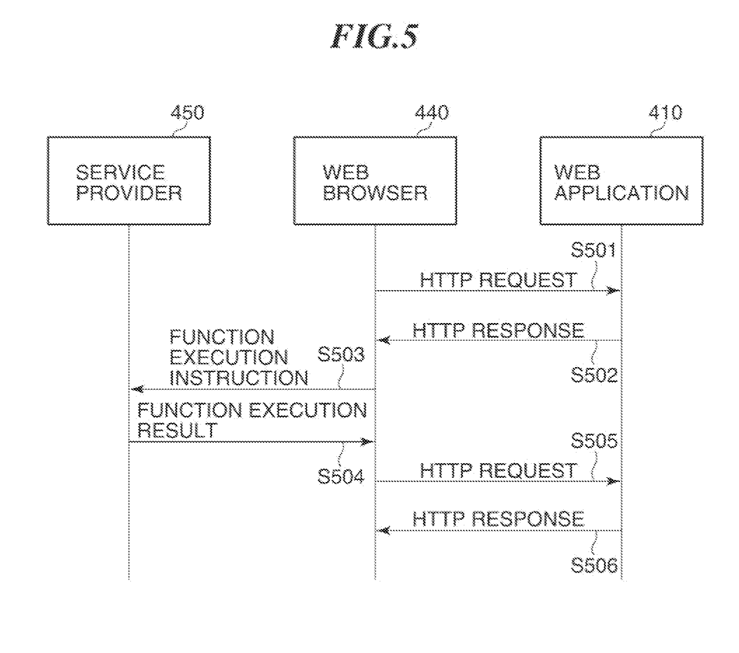

As shown in FIG. 1, the MFP 100 of this embodiment is connected for communication with a server 200 through a network 130, which is implemented by e.g., a LAN. In the MFP 100, a browser 440 (see FIG. 4A) operates and executes a web application 410 (see FIG. 4B) running on the server 200.

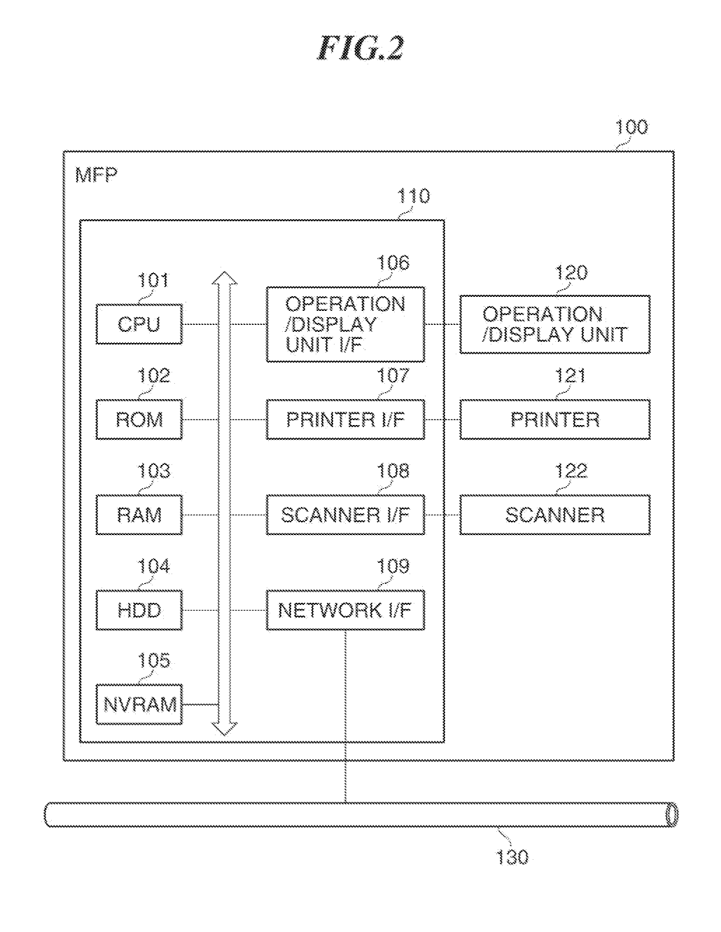

FIG. 2 shows in block diagram an example structure of the MFP 100. As shown in FIG. 2, the MFP 101 has a control unit 110 that includes a CPU 101, ROM 102, RAM 103, HDD 104, NVRAM 105, operation/display unit I/F 106, printer I/F 107, scanner I/F 108, and network I/F 109.

The CPU 101 reads a control program stored in the ROM 102 into the RAM 103, and based on the control program, executes scanner reading control, transmission control, etc., thereby controlling operations of the entire MFP 100. The ROM 102 stores a boot program, fixed parameters, etc. The RAM 103 is used by the CPU 101 as a main memory and a temporary storage region such as a work area. The HDD 104 stores image data, various programs, etc. A NVRAM 105 stores various setting values for the MFP 100.

The operation/display unit I/F 106 is an interface for connection with an operation/display unit 120 provided with, e .g., a keyboard and a liquid crystal display unit having a touch panel function. The operation/display unit 120 displays various information and accepts a user's instruction input. The printer I/F 107 is an interface for connection with a printer 121. Image data transferred to the printer 121 via the printer I/F 107 is printed on a sheet by the printer 121.

The scanner I/F 108 is an interface for connection with a scanner 122 that reads an image of an original. The scanner 122 creates image data, and outputs the image data to the control unit 110 via the scanner I/F 108. The network I/F 109 is an interface through which the MFP 100 is connected to the network 130. The network I/F 109 transmits image data and information to an external apparatus (e.g., server 200) connected to the network 130, and receives information from the external apparatus.

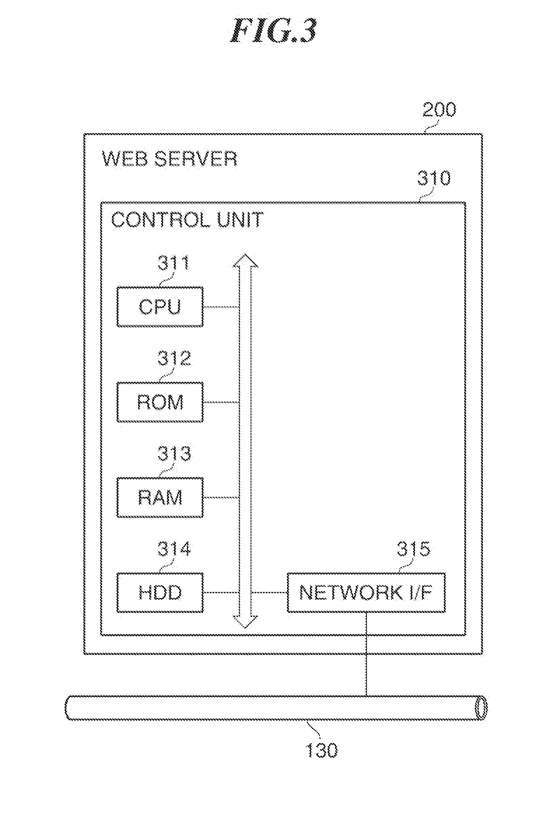

FIG. 3 shows in block diagram an example structure of the server 200. As shown in FIG. 3, the server 200 has a control unit 310 including a CPU 311, ROM 312, RAM 313, HDD 314, and network I/F 315.

The CPU 311 reads and executes a control program stored in the ROM 312 to control the entire server 200. The RAM 313 is used by the CPU 311 as a main memory and a temporary storage region such as a work area. The HDD 314 stores image data, programs, and information tables (described later).

The network I/F 315 is an interface for connection with the network 130, and transmits and receives various information to and from the MFP 100 or other apparatuses connected to the network 130.

FIG. 4A shows in block diagram an example software structure of the MFP 100.

As shown in FIG. 4A, MFP 100 includes the browser 440, service provider 450, and job status management unit 460.

The browser 440 has a communication part 441, analysis part 442, screen display control part 443, script execution part 444, screen operation control part 445, and cookie information management part 446.

The communication part 441 communicates with a presentation part 411 (described later) of the web application 410 of the server 200 according to HTTP protocol. More specifically, the communication part 441 transmits to the web application 410 a request message requesting the web application 410 to transmit data used by the browser 440 to display an operation screen, and receives a response message from the web application 410.

Further, the communication part 441 transmits to a communication part 451 of the service provider 450 a request message requesting execution of a function, and receives a response message from the service provider 450.

The analysis part 442 analyzes the response message received from the web application 410 of the server 200. The response massage includes HTML data and a control script. The HTML data contains a description indicating the contents of an operation screen to be displayed on the operation/display unit 120. The control script contains a description indicating the contents of control to be executed to achieve a function of the MFP 100.

Based on a result of HTML data analysis by the analysis part 442, the screen display control part 443 causes the operation/display unit 120 to display an operation screen. The script execution part 444 performs processing based on a result of control script analysis by the analysis part 442. The control script contains a code for giving an instruction to control a function of the MFP 100 to the service provider 450, and a code for performing processing (such as updating the operation screen) in response to a response from the service provider 450.

The screen operation control part 445 performs control of a user interface of the browser 440. For example, it performs processing to make input buttons effective/non-effective or displayed/non-displayed. According to instructions given by the control script executed by the script execution part 444, the cookie information management part 446 executes processing such as reading and writing the cookie information from and into the script execution part 444 and clearing the cookie information.

The service provider 450 includes a communication part 451 and job creation part 452.

The communication part 451 receives from the communication part 441 of the browser 440 a request message that requests to generate a job. The job creation part 452 analyzes the request message received by the communication part 451, and based on a result of the analysis, generates and executes a job to execute the requested processing.

The job status management unit 460 includes a status determination part 461 and status notification part 462.

The status determination part 461 manages the status (execution state) of a job executed by the job creation part 452, and executes processing according to the job status. The status notification part 462 monitors the status of the job managed by the status determination part 461, and notifies the job status to the screen operation control part 445 of the browser 440 when the job status changes.

The job status management unit 460 can be provided in either the browser 440 or the service provider 450. In a case where the management unit 460 is provided in the service provider 450, the status notification part 462 notifies the communication part 451 of the job status managed by the status determination part 461 when the job status changes. The communication part 451 transmits the job status notified from the status notification part 462 to the communication part 441 of the browser 440, thereby notifying the screen operation control part 445 of the job status.

FIG. 4B shows in block diagram an example software structure of the server 200.

As shown in FIG. 4B, the web application 410 of the server 200 includes the presentation part 411 and a logic part 412.

The presentation part 411 communicates with the communication part 441 of the browser 440 of the MFP 100, receives a request message from the browser 440, notifies the received request message to the logic part 412, and waits for reception of a response from the logic part 412. Based on the request message notified from the presentation part 411, the logic part 412 generates HTML data corresponding to an operation screen to be displayed on the operation/display unit 120 and a control script for the processing to be executed by the MFP 100. The presentation part 411 receives from the logic part 412 the HTML data and the control script, and transmits a response message including the HTML data and the control script to the browser 440.

For example, based on the received control script, the MFP 100 causes the printer 121 to perform printing and causes the scanner 122 to perform reading, or causes the network I/F 109 to perform transmission processing.

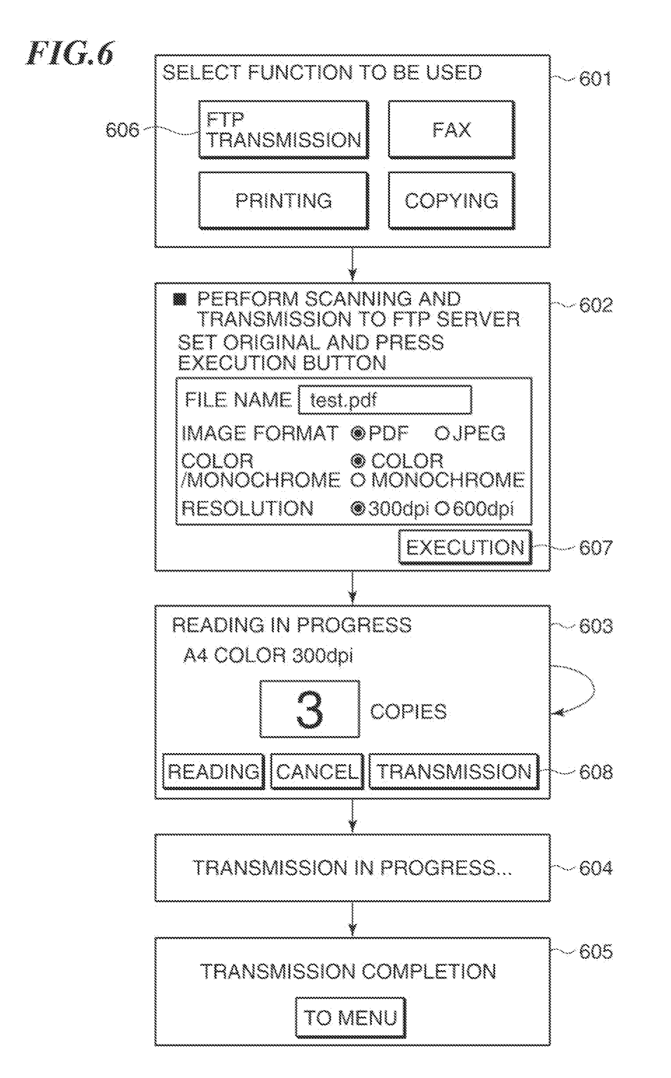

Next, with reference to FIG. 5, a description will be given of a series of processing performed between the browser 440 of the MFP 100, the service provider 450 of the MFP 100, and the web application 410 of the server 200.

When the browser 440 of the MFP 100 is activated by a user, the browser 440 sends an HTTP request to the web application 410 in step 5501 in FIG. 5.

In step S502, based on the received HTTP request, the web application 410 generates HTML data corresponding to an operation screen to be displayed on the operation/display unit 120 by the browser 440 and a control script to be executed by the browser 440, and delivers to the browser 440 an HTTP response including the HTML data and the control script.

In a case, for example, that the received HTTP request corresponds to a menu screen, the web application 410 delivers to the browser 440 an HTTP response including HTML data for displaying the menu screen. In a case that the received HTTP request corresponds to an operation screen used for scan execution, the web application 410 delivers to the browser 440 an HTTP response including HTML data for displaying a scan screen and a control script for executing scanning.

In step S503, the browser 440 analyzes the HTML data received from the web application 410 and causes the operation/display unit 120 to display an operation screen. The browser 440 also analyzes the control script received from the web application 410 and instructs the service provider 450 to execute a function of the MFP 100.

In step S504, the service provider 450 executes the function of the MFP 100 according to the instruction given by the browser 440 in step S503, and notifies the browser 440 of an execution result.

In step S505, the browser 440 causes the control script to process the function execution result notified from the service provider 450 in step S504, to thereby perform processing according to the execution result.

In this example, the browser 440 again delivers an HTTP request to the web application 410 according to the notified function execution result. In a case, for example, that the notified function execution result indicates completion of the processing, the browser 440 delivers an HTTP request to display a processing completion screen. In a case that the notified function execution result indicates some error, the browser 440 delivers an HTTP request to display an error processing screen.

In step S506, based on the contents of the HTTP request delivered from the browser 440 in step S505, the web application 410 generates a control script and HTML data corresponding to an operation screen, and delivers to the browser 440 an HTTP response including the HTML data and the control script. The above-described processing is repeated, whereby a series of processing is executed to achieve a function of the MFP 100.

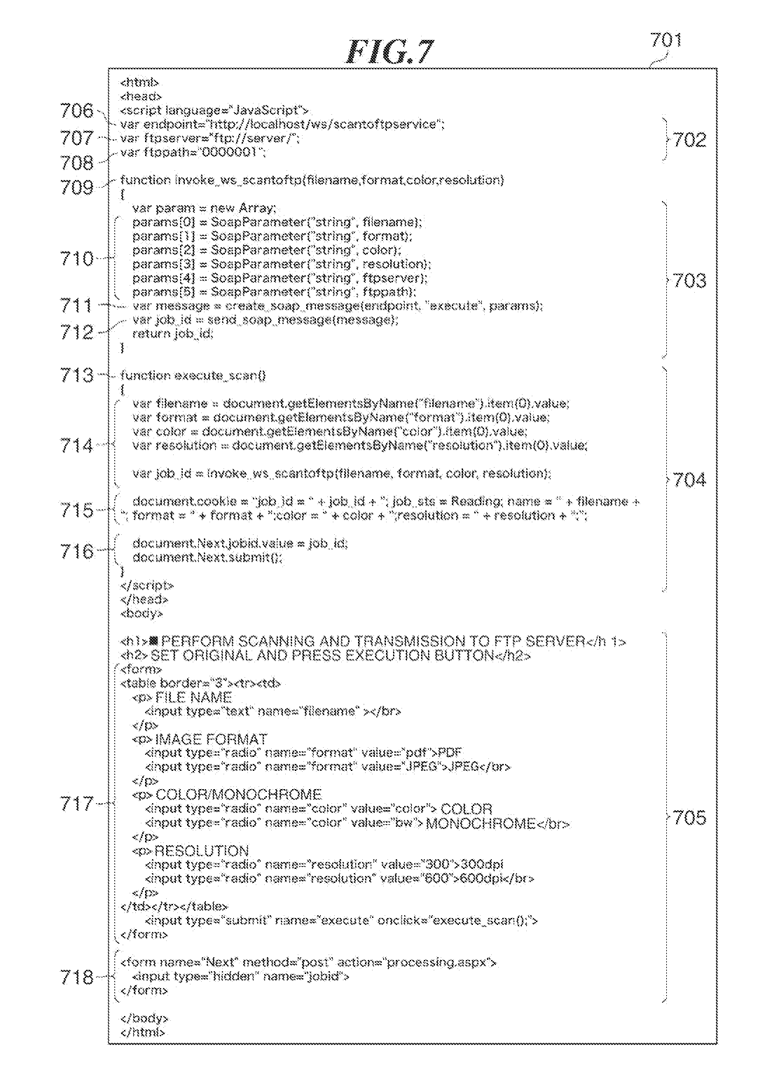

FIG. 6 shows an example of screen transition occurring on the operation/display unit 120 while a series of processing is performed to achieve a function of the MFP 100.

As shown in FIG. 6, in this embodiment, a menu screen 601, FTP transmission setting screen 602, scan-in-progress screen 603, transmission-in-progress screen 604, and transmission completion screen 605 are displayed in this order on the operation/display unit 120 by the browser 440 according to user's operations. It should be noted that the screen transition can also be achieved according to the control script.

The menu screen 601 is for selecting which of functions of the MFP 100 is to be used. When a desired function is selected on the menu screen 601 by the user, a transition is made to the screen corresponding to the selected function.

The FTP transmission setting screen 602 is displayed on the operation/display unit 120 when an FTP transmission button 606 is pressed on the menu screen 601 by the user to select an FTP transmission function. On the screen 602, a setting of FTP transmission is made and an instruction for execution of the FTP transmission function is given.

The scan-in-progress screen 603 is displayed in a state where the FTP transmission function is being executed when an execution button 607 is pressed by the user on the FTP transmission setting screen 602. In that state, a scan job is controlled by the control script, whereby originals are continuously read, for example.

The transmission-in-progress screen 604 is displayed in a state where image data of scanned originals is being transmitted to an FTP server when a transmission button 608 is pressed by the user on the scan-in-progress screen 603.

The transmission completion screen 605 is displayed when the transmission of the image data to the FTP server is completed.

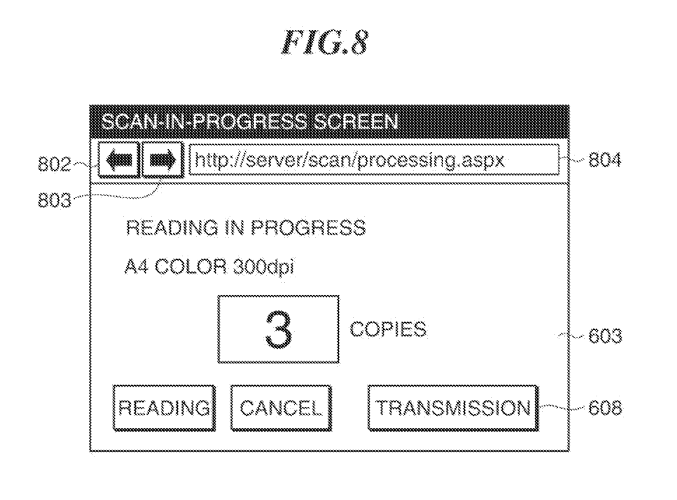

FIG. 7 shows an example of a control script and

HTML data for screen display. In the example of FIG. 7, there is shown data 701 that includes a control script and HTML data corresponding to the FTP transmission setting screen 602. The data 701 is created by the server 102 in response to a request from the MFP 100. In this example, the control script is written in Java (registered trademark) script (hereinafter, referred to as Java script).

As shown in FIG. 7, the data 701 is divided into blocks 702 to 705, which are described below.

The block 702 is set with a part of parameters, which are used by the web application 410 to perform FTP transmission. An endpoint variable 706 is set with URL information according to which a request is delivered to the service provider 450. An ftpserver variable 707 is set with URL information of the FTP server to which data is transmitted. An ftppath variable 708 is set with a path to the FTP server that stores the data.

In the block 703, processing for calling the service provider 450 is written. The service provider 450 is called by using SOAP in this example. An invoke_ws_scantoftp function 709 is defined. A SoapParameter function 710 is for generating parameters in SOAP form. In this example, a file name, file format, color setting, resolution, transmission destination FTP server, and storage destination path for FTP transmission are set as “String” type data.

A create_soap_message function 711 generates a SOAP message that gives the endpoint an execution instruction. A send_soap_message function 712 transmits a SOAP request to the service provider 450. A job_id variable represents a job ID that uniquely identifies an

FTP transmission job and that is sent back from the endpoint in reply to the SOAP request.

In the block 704, an execute_scan function 713 is defined. Calling processing 714 is executed by executing the invoke_ws_scantoftp function 709 that includes, as parameters, a file name, file format, and resolution for FTP transmission, which are input by a user. Further, processing 715 is executed to store into a cookie a job ID, job status, file name, file format, color setting, and resolution, which are obtained as an execution state of the invoke_ws_scantoftp function 709. By executing the processing 715, the control script can be continued based on setting information stored in the cookie, even if the control script is interrupted while the job is being called. Further, processing 716 is performed to instruct execution of request processing for acquisition of the next screen data, while using as a parameter the job ID obtained as the execution state of the invoke_ws_scantoftp function 709.

In the block 705, contents of a screen to be displayed on the operation/display unit 120 by the browser 440, a user input form 717, and a form 718 to make an HTTP request for the next screen are defined. With the user input form 717, it is possible, for example, to input a file name for FTP transmission and select a file format for FTP transmission. The execute_scan function 713 is called when the execution button is pressed.

When an execution instruction is given by the processing 716 in the block 704, the form 718 is executed to make a POST request to processing.aspx, while using the job ID as a parameter.

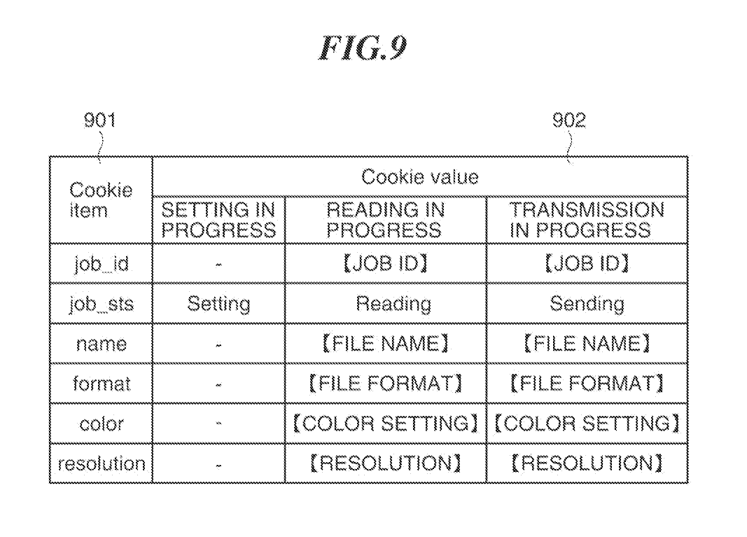

FIG. 8 shows an example of the scan-in-progress screen 603 (FIG. 6) displayed by the browser 440 on the operation/display unit 120 along with an operation screen for screen transition.

In FIG. 8, a return button 802 is for making a transition or changeover from a currently displayed screen to an immediately preceding screen. A proceed button 803 is for returning from the screen after the changeover, which is displayed by operating the return button 802, to the screen before the changeover. An address field 804 displays a URL of the currently displayed screen. Also, by directly inputting a URL into the address field 805, the screen display can be changed and an HTTP request can be delivered to the input URL. Each of the return button 803, proceed button 804, and address field 805 is operable independently of the screen 801. In other words, when any of the return button 802, proceed button 803 and address field 804 is operated while a job is being executed, a control script (job control) currently executed is interrupted and a shift is made to another screen.

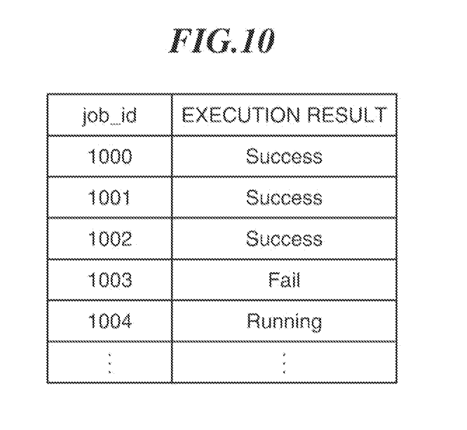

FIG. 9 shows an example of cookie information stored in the browser 440 (cookie information management part 446) of the MFP 100. The cookie information is stored by the processing 715 shown in FIG. 7.

In FIG. 9, reference numerals 901 and 902 respectively denote a cookie item field and a cookie value field. The cookie item field 901 includes six items, i.e., job_id, job_sts, name, format, color, and resolution items that represent job ID, job status, file name, file format, color setting, and resolution, respectively. Pieces of information about each item of the cookie item field 901 are stored into two or three sub-fields, which respectively correspond to two or three job statuses (described below). In other words, the pieces of information about the six items of the cookie item. field 901 are each associated with the corresponding job status.

When the screen 602 shown in FIG. 6 is displayed on the operation/display unit 120, the job status is in a “setting in progress” state (Setting state). In the Setting state, only information “Setting” about the item “job_sts” of the cookie item field 901 is stored into a “setting in progress” sub-field of the cookie value field 902. When the screen 603 shown in FIG. 6 is displayed on the operation/display unit 120, the job status is in a “reading in progress” state (Reading state). In the Reading state, information “Reading” and values set on the screen 602 are stored, as the information about the items of the cookie item field 901, into a “reading in progress” sub-field of the cookie value field 902. When the screen 604 shown in FIG. 6 is displayed on the operation/display unit 120, the job status is in a “transmission in progress” state (Sending state). In the Sending state, information “Sending” and values set on the screen 602 are stored, as the information about the items of the cookie item field 901, into a “transmission in progress” sub-field of the cookie value field 902.

When calling a job according to a control script, the browser 440 stores cookie information representing a job execution state into the cookie information management part 446, as shown in FIG. 9. Even if the control script is interrupted, the job in execution can be therefore continued by referring to the cookie information.

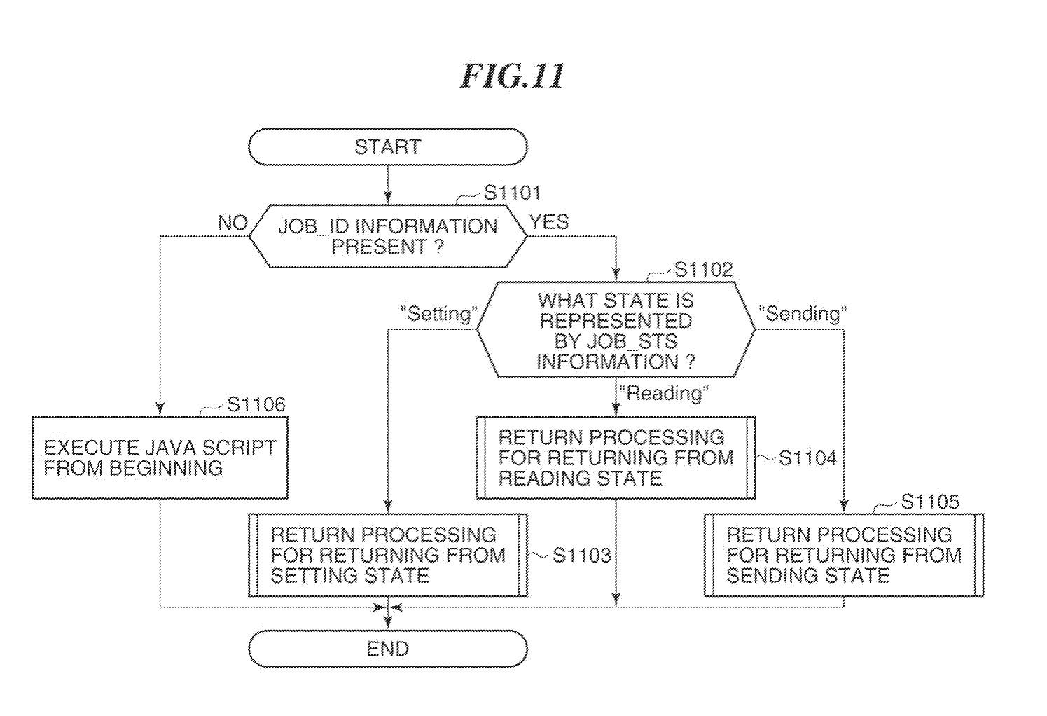

FIG. 10 shows an example of a list of job execution results managed by the status determination part 461 of the MFP 100.

As shown in FIG. 10, the status determination part 461 manages job execution results in association with job_ids. Information “Success” stored in an execution result field of the list indicates that a job represented by a job_id corresponding to the information “Success” has succeeded. Information “Fail” indicates that a job represented by a job_id corresponding to the information “Fail” has failed, i.e., indicates that the job has not been completed normally. Information “Running” indicates that a job represented by a job_id corresponding to the information “Running” is in execution.

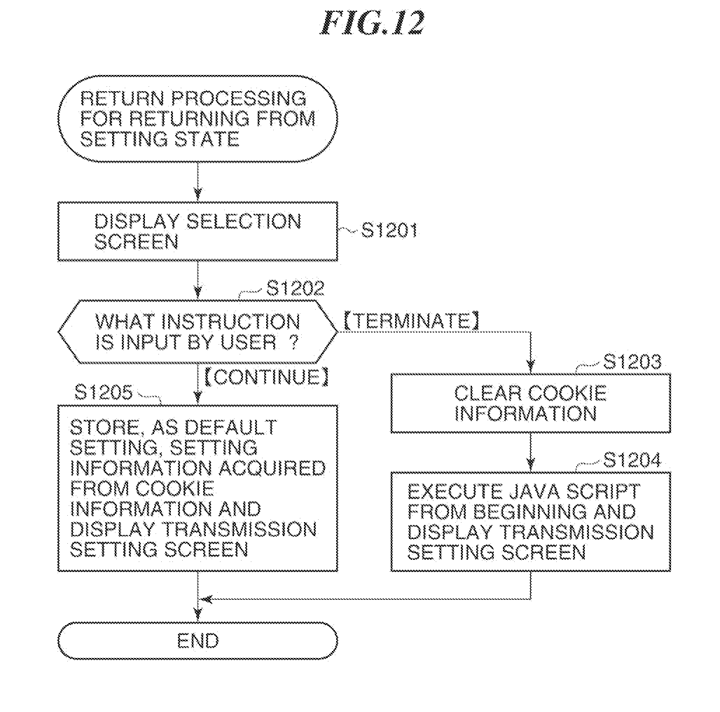

Next, with reference to FIG. 11, a description will be given of a process performed by the MFP 100 by executing a web application. This process is performed by the CPU 101 of the MFP 100 by loading a control program stored in, e.g., the ROM 102 or the HDD 104 into the RAM 103 and by executing the loaded program. The process shown in FIG. 11 is started when the FTP transmission button 606 is pressed on the menu screen 601 shown in FIG. 6.

In step S1101, the CPU 101 confirms based on the cookie information whether information about the “job_id” item of the cookie item field 901 is present in the cookie value field 902. If job_id information is not present, the CPU 101 determines that there is no job which is in execution and proceeds to step S1106. If job id information is present, the CPU 101 determines that there is a job in execution and proceeds to step S1102.

In step S1106, the CPU 101 executes a Java script from beginning, and completes the present process.

In step S1102, the CPU 101 acquires information about the “job_sts” item of the cookie item field 901 from the cookie value field 902.

If the acquired information about the “job_sts” item is “Setting,” the CPU 101 proceeds to step S1103 where return processing for returning from the Setting state is performed. If the acquired information about the “job_sts” item is “Reading,” the CPU 101 proceeds to step S1104 where return processing for returning from the Reading state is performed. If the acquired information about the “job_sts” item is “Sending,” the CPU 101 proceeds to step S1105 to perform return processing for returning from the Sending state.

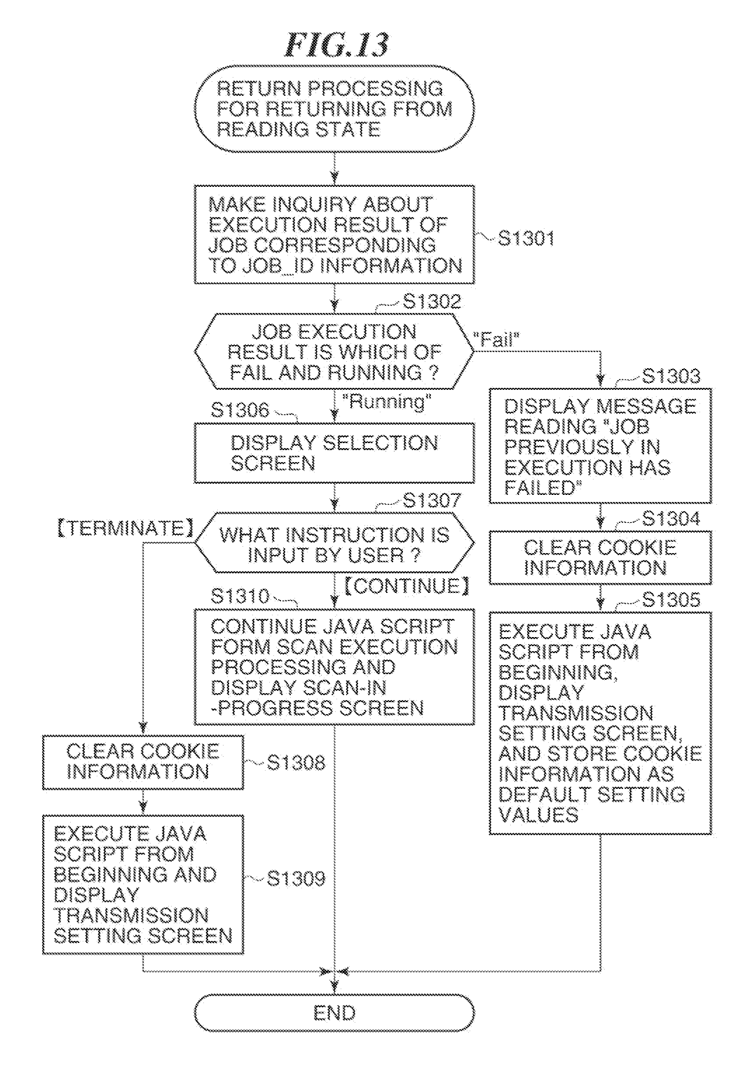

FIG. 12 shows in flowchart the return processing performed instep S1103 in FIG. 11 when there is a job which is in the Setting state.

In step S1201, the CPU 101 causes the browser 440 to display on the operation/display unit 120 a selection screen that displays a message reading “There is a job in execution. Do you wish to continue?” and proceeds to step S1202 where the CPU 101 waits for reception of a continue instruction or a terminate instruction from a user.

In step S1202, the CPU 101 causes the browser 440 to analyze a user's input, and proceeds to step S1203 when it receives a terminate instruction. When receiving a continue instruction, the CPU 101 proceeds to step S1205.

In step S1203, the CPU 101 causes the browser 440 to clear the cookie information, and proceeds to step S1204.

In step S1204, the CPU 101 causes the browser 440 to execute a Java script from beginning, causes the operation/display unit 120 to display the FTP transmission setting screen 602, and completes the present process.

In step S1205, the CPU 101 causes the browser 440 to read values of the name, format, color, and resolution items of the cookie item field 901 from the cookie value field 902 of the cookie information, and stores the read values as default values of file name, file format, color setting, and resolution. Then, the CPU 101 causes the operation/display unit 120 to display the FTP transmission setting screen 602, and completes the present process.

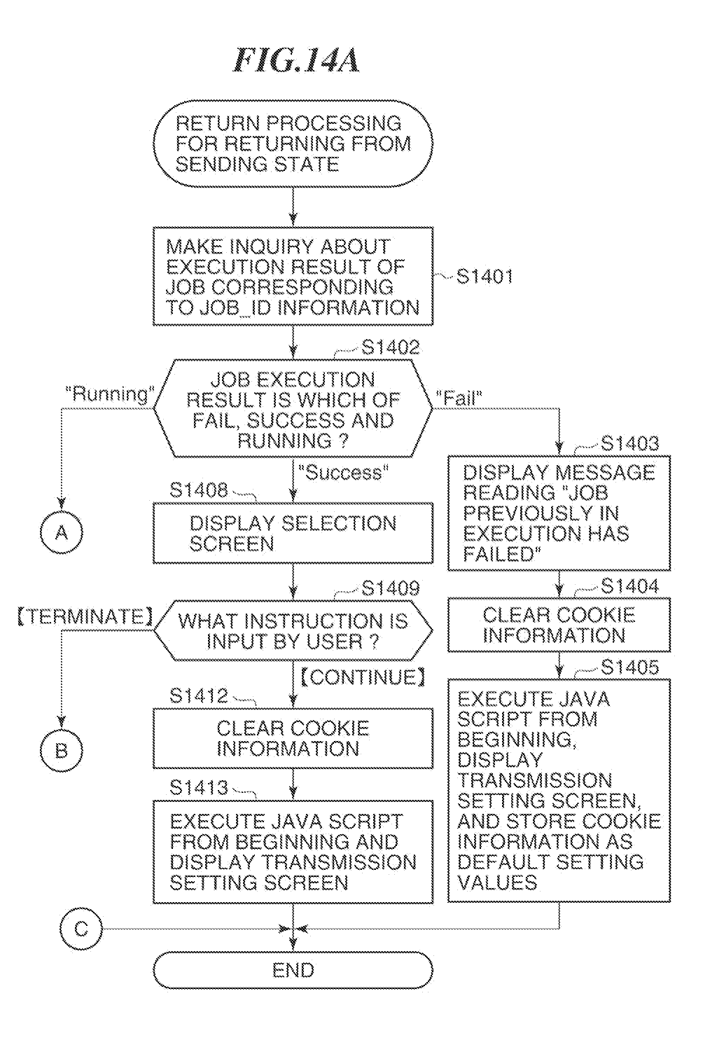

FIG. 13 shows in flowchart the return processing performed instep S1104 in FIG. 11 when there is a job which is in the “Reading” state.

In step S1301, the CPU 101 causes the browser 440 to acquire information about the job id item of the cookie item field 901 from the cookie value field 902. Then, the CPU 101 causes the browser 440 to make an inquiry about a job execution result to the job status management unit 460 via the service provider 450, and proceeds to step S1302.

In step S1302, the CPU 101 causes the browser 440 to analyze the job execution result obtained by the inquiry in step S1301. If the job execution result is “Fail,” the CPU 101 determines that the job has failed and has been canceled, and proceeds to step 51303. If the job execution result is “Running,” the CPU 101 determines that the job is in execution, and proceeds to step S1306.

In step S1303, the CPU 101 causes the browser 440 to display on the operation/display unit 120 a message reading “Job previously in execution has failed” and then proceeds to step S1304.

In step S1304, the CPU 101 causes the browser 440 to clear the cookie information and proceeds to step S1305.

In step S1305, the CPU 101 causes the browser 440 to execute a Java script from beginning and causes the operation/display unit 120 to display the FTP transmission setting screen 602. At that time, the CPU 101 stores information about the name, format, color, and resolution items of the cookie information as default setting values.

In step S1306, the CPU 101 causes the browser 440 to display on the operation/display unit 120 a selection screen that displays a message reading “There is a job in execution. Do you wish to continue?” and proceeds to step S1307 where the CPU 101 waits for reception of a continue instruction or a terminate instruction from the user.

In step S1307, the CPU 101 causes the browser 440 to analyze a user's input, and proceeds to step S1308 when it receives a terminate instruction. When receiving a continue instruction, the CPU 101 proceeds to step S1310.

In step S1308, the CPU 101 causes the browser 440 to clear the cookie information and proceeds to step S1309.

In step S1309, the CPU 101 causes the browser 440 to execute a Java script from beginning, causes the operation/display unit 120 to display the FTP transmission setting screen 602, and completes the present process.

In step S1310, the CPU 101 causes the browser 440 to display the scan-in-progress screen 603 on the operation/display unit 120 and to continue the Java script from scan execution processing, and completes the present process.

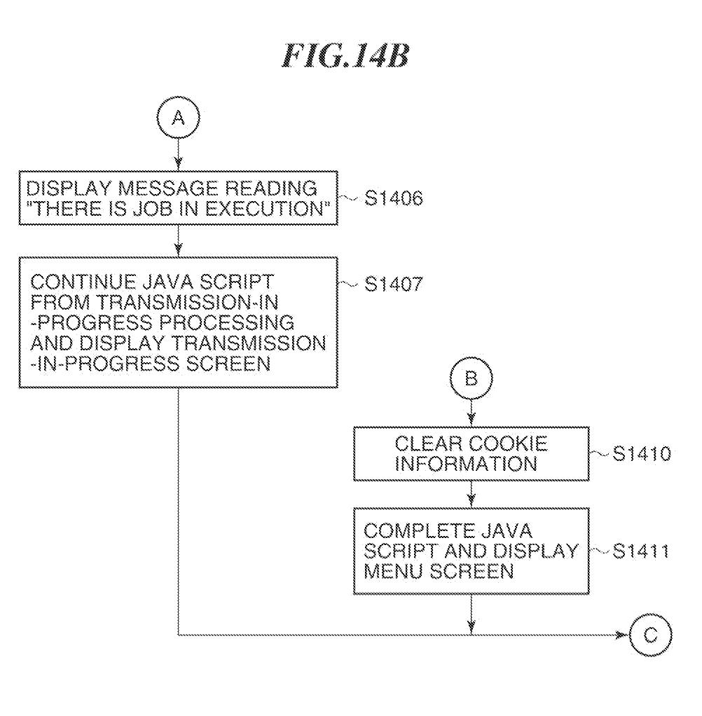

FIGS. 14A and 14B show in flowchart the return processing performed in step S1105 in FIG. 11 when there is a job which is in the “Sending” state.

In step S1401, the CPU 101 causes the browser 440 to acquire information about the job_id item of the cookie item field 901 from the cookie value field 902. Then, the CPU 101 causes the browser 440 to make an inquiry about a job execution result to the job status management unit 460 via the service provider 450, and proceeds to step S1402.

In step S1402, the CPU 101 causes the browser 440 to analyze the job execution result obtained by the inquiry in step S1401. If the job execution result is “Fail”, the CPU 101 determines that the job has failed and has been cancelled, and proceeds to step S1403. If the job execution result is “Running,” the CPU 101 determines that the job is in execution, and proceeds to step S1406. If the job execution result is “Success,” the CPU 101 determines that the job has been completed successfully, and proceeds to step S1408.

In step S1403, the CPU 101 causes the browser 440 to display on the operation/display unit 120 a message reading “Job previously in execution has failed” and then proceeds to step S1404.

In step S1404, the CPU 101 causes the browser 440 to clear the cookie information, and proceeds to step S1405.

In step S1405, the CPU 101 causes the browser 440 to execute a Java script from beginning and causes the operation/display unit 120 to display the FTP transmission setting screen 602. At that time, the CPU 101 stores information about the name, format, color, and resolution in the cookie item field 901 as default setting values.

In step S1406, the CPU 101 causes the browser 440 to display on the operation/display unit 120 a message reading “There is a job in execution.” and proceeds to step S1407.

In step S1407, the CPU 101 causes the browser 440 to display the transmission-in-progress screen 604 on the operation/display unit 120, continues the Java script from transmission-in-progress processing, and completes the present process.

In step S1408, the CPU 101 causes the browser 440 to display on the operation/display unit 120 a message reading “ Job previously in execution has succeeded. Do you wish to continue?” and proceeds to step S1409 where the CPU 101 waits for reception of a continue instruction or a terminate instruction from the user.

In step S1409, the CPU 101 causes the browser 440 to analyze a user's input, and proceeds to step S1410 when it receives a terminate instruction. When receiving a continue instruction, the CPU 101 proceeds to step S1412.

In step S1410, the CPU 101 causes the browser 440 to clear the cookie information and proceeds to step S1411.

In step S1411, the CPU 101 causes the browser 440 to complete the Java script, causes the operation/display unit 120 to display the menu screen 601, and completes the present process.

In step S1412, the CPU 101 causes the browser 440 to clear the cookie information and proceeds to step S1413.

In step S1413, the CPU 101 causes the browser 440 to execute a Java script from beginning, causes the operation/display unit 120 to display the FTP transmission setting screen 602, and completes the present process.

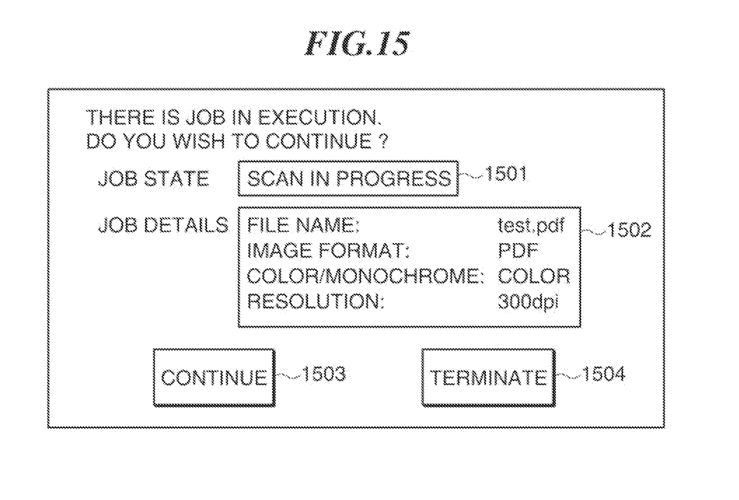

FIG. 15 shows an example of the selection screen which is displayed on the operation/display unit 120 in step S1306 in FIG. 13 and through which the user instructs whether to continue or terminate processing.

In the example shown in FIG. 15, a message reading “There is a job in execution. Do you wish to continue?” is displayed on the selection screen together with a “job state” field 1501 for indicating job_sts information acquired from the cookie information stored in the MFP 100 and a “job details” field 1502 for indicating pieces of information about name, format, color, and resolution acquired from the cookie information. When a continue button 1503 is pressed, the scan-in-progress screen 603 is displayed and processing is continued. When a terminate button 1504 is pressed, processing on the job is terminated and the FTP transmission setting screen 602 is displayed.

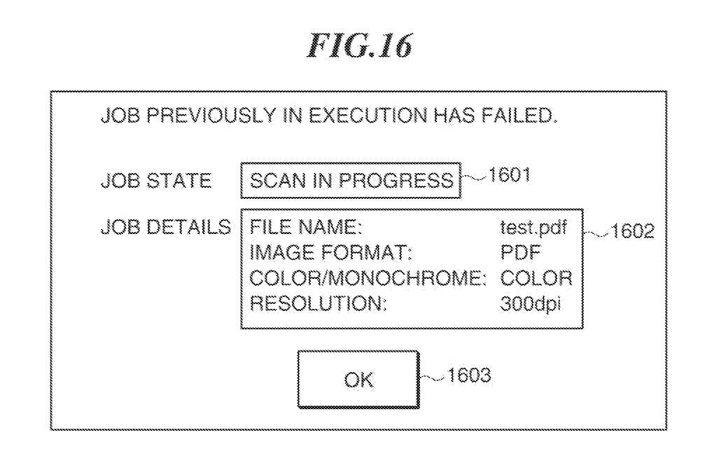

FIG. 16 shows an example of the screen displayed on the operation/display unit 120 in step S1303 in FIG. 13 to notify the user that a job previously in execution has failed.

In the example shown in FIG. 16, a message reading “Job previously in execution has failed” is displayed on the screen together with a “job state” field 1601 for indicating job_sts information acquired from the cookie information stored in the MFP 100 and a “job details” field 1602 for indicating pieces of information about name, format, color, and resolution acquired from the cookie information. When an OK button 1603 is pressed, the cookie information is cleared and processing is started from the FTP transmission setting screen 602.

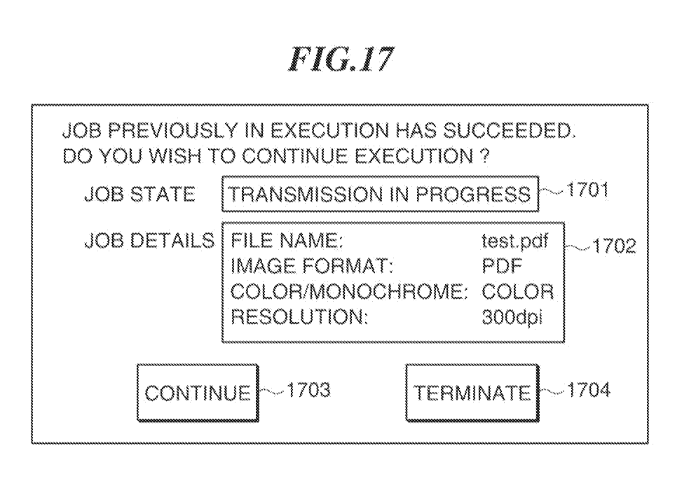

FIG. 17 shows an example of the screen displayed on the operation/display unit 120 in step S1408 in FIG. 14A to notify the user that a job previously in execution has succeeded.

In the example shown in FIG. 17, a message reading “Job previously in execution has succeeded” is displayed on the screen together with a “job state” field 1701 for indicating job_sts information acquired from the cookie information stored in the MFP 100 and a “job details” field 1702 for indicating pieces of information about name, format, color, and resolution acquired from the cookie information. When a continue button 1703 is pressed, the cookie information is cleared and processing is started from the FTP transmission setting screen 602. When a terminate button 1704 is pressed, the Java script is completed and the menu screen 601 is displayed.

As described above, according to this embodiment, even if the user performs an operation to cause the browser 440 to transit an operation screen displayed on the operation/display unit 120 to another screen while a job is being executed, it is possible to continue the execution of the job performed thus far. In a case where a job previously in execution has not been completed normally, setting values for the job previously in execution can be stored as default setting values (initial values), and therefore the user is not required to make the settings again.

### Other Embodiments

Aspects of the present invention can also be realized by a computer of a system or apparatus (or devices such as a CPU or MPU) that reads out and executes a program recorded on a memory device to perform the functions of the above-described embodiment, and by a method, the steps of which are performed by a computer of a system or apparatus by, for example, reading out and executing a program recorded on a memory device to perform the functions of the above-described embodiment. For this purpose, the program is provided to the computer for example via a network or from a recording medium of various types serving as the memory device (e.g., computer-readable medium).

While the present invention has been described with reference to an exemplary embodiment, it is to be understood that the invention is not limited to the disclosed exemplary embodiment. The scope of the following claims is to be accorded the broadest interpretation so as to encompass all such modifications and equivalent structures and functions.

This application claims the benefit of Japanese Patent Application No. 2010-111208 filed on May 13, 2010, which is hereby incorporated by reference herein in its entirety.

What is claimed is:

1. An information processing apparatus comprising:
a display control unit configured to switchingly display operation screens on a display unit according to a user's operation, the operation screens being provided from an external apparatus;
a job execution unit configured to execute a job according to a user's operation on an operation screen displayed on the display unit; and
a storage unit configured to store setting information for the job executed by said job execution unit,
wherein in a case where the operation screen displayed on the display unit is switched according to a user's operation while the job is being executed by said job execution unit, said job execution unit continues the job in execution based on the setting information for the job stored in said storage unit.

2. The information processing apparatus according to claim 1, wherein said display control unit displays on the display unit a screen for selecting whether to continue the job in execution according to a user's operation.

3. The information processing apparatus according to claim 1, wherein said display control unit causes the setting information for the job stored in said storage unit to be displayed on the display unit.

4. A control method for an information processing apparatus, comprising:
switchingly displaying operation screens on a display unit according to a user's operation, the operation screens being provided from an external apparatus;
causing a job execution unit to execute a job according to a user's operation on an operation screen displayed on the display unit; and
storing setting information for the job executed by the job execution unit into a storage unit,
wherein in a case where the operation screen displayed on the display unit is switched according to a user's operation while the job is being executed by the job execution unit, the job in execution is continued based on the setting information for the job stored in the storage unit.

5. A non-transitory computer-readable storage medium storing a program for causing an information processing apparatus to execute the control method as set fourth in claim 4.
